(19) United States
(12) Patent Application Publication
(10) Pub. No.: US 2026/0111955 A1
(43) Pub. Date: Apr. 23, 2026

(54) SERVER AND PROGRAM

(71) Applicant: GLOBAL MOBILITY SERVICE INC., Tokyo (JP)

(72) Inventors: Marei OSHIMA, Minato-ku, Tokyo (JP); Tokushi NAKASHIMA, Minato-ku, Tokyo (JP)

(21) Appl. No.: 18/695,357

(22) PCT Filed: Sep. 29, 2022
(86) PCT No.: PCT/JP2022/036463

§ 371 Date: Mar. 26, 2024

(30) Foreign Application Priority Data
Sep. 29, 2021 (JP) 2021-158766

(51) Int. Cl. G06Q 40/03

(52) U.S. Cl. CPC G06Q 40/033

(57) ABSTRACT

A server according to an embodiment includes: an acquisition unit that acquires operating information and location information on a vehicle of a user; a management unit that manages the user, a prescribed time, and a prescribed area in association; a first calculation unit that calculates, based on the operating information and the location information on the vehicle, an integrated value of a time of working of the user in the prescribed area within the prescribed time; a second calculation unit that calculates, based on the integrated value, a score for the user; and a modification unit that modifies, based on the score, at least one of a period of repayment, an amount of repayment, or interest rate.

### CROSS REFERENCE TO RELATED APPLICATIONS

This is a U.S. National Phase Application under 35 U.S.C. § 371 of International Patent Application No. PCT/JP2022/036463, filed Sep. 29, 2022, which claims priority of Japanese Patent Application No. 2021-158766, filed Sep. 29, 2021, the entire contents of which are hereby incorporated by reference.

### TECHNICAL FIELD

The present invention relates to a server and a program.

### BACKGROUND ART

Many of the workers who want to improve their lives working as drivers. Because credit assessment has not been carried out properly to such drivers to complete loan repayment, there is no difference in the terms of loan repayment between hardworking drivers and non-hardworking drivers. Thus, it has been said that the lives of many hardworking drivers do not improve.

For improvement of such a situation, there is a known technique of calculating, based on vehicular operating information collected from an onboard device mounted on the vehicle that each driver uses, credit information on each driver and enabling, based on the credit information, each driver to borrow money from a financial institution (e.g., refer to Patent Literature 1 or 2).

### CITATION LIST

### Patent Literature

Patent Literature 1: WO 2019/193665 A
Patent Literature 2: JP 6840346 B2

### SUMMARY OF INVENTION

After borrowing from a financial institution is carried out in practice based on the credit information calculated by such a technique as described above, modifications are made in the terms of repayment to the borrowings of hardworking drivers to achieve further improvement of their lives, leading to rises in the drivers' wills to work.

However, the technique disclosed in Patent Literature 1 does not focus on such an aim.

The Patent Literature 2 focuses on the aim described above but does not disclose how to achieve the aim specifically.

Thus, the present invention has been made in consideration of the above problem and an object of the present invention is to provide a server and a program that enable to achieve further improvement of hardworking drivers' lives and that enable increase the drivers' motivation to work.

A server according to an embodiment includes: an acquisition unit that acquires operating information and location information on a vehicle of a user; a management unit that manages the user, a prescribed time, and a prescribed area in association; a first calculation unit that calculates, based on the operating information and the location information on the vehicle, an integrated value of a time of working of the user in the prescribed area within the prescribed time; a second calculation unit that calculates, based on the integrated value, a score for the user; and a modification unit that modifies, based on the score, at least one of a period of repayment, an amount of repayment, or interest rate.

A program according to an embodiment for causing a computer to function as a server, the server includes: an acquisition unit that acquires operating information and location information on a vehicle of a user; a management unit that manages the user, a prescribed time, and a prescribed area in association; a first calculation unit that calculates, based on the operating information and the location information on the vehicle, an integrated value of a time of working of the user in the prescribed area within the prescribed time; a second calculation unit that calculates, based on the integrated value, a score for the user; and a modification unit that modifies, based on the score, at least one of a period of repayment, an amount of repayment, or interest rate.

According to the present invention, it is possible to provide a server and a program that can achieve an object of modifying the terms of repayment to the borrowings of hardworking drivers.

### BRIEF DESCRIPTION OF THE DRAWINGS

FIG. 1 illustrates an exemplary entire configuration of a service providing system 100 according to an embodiment.

FIG. 2 illustrates exemplary functional blocks of a server 10 according to the embodiment.

FIG. 3 is a table of exemplary data managed by a management unit 12 of the server 10 according to the embodiment.

FIG. 4 is a table of exemplary data managed by the management unit 12 of the server 10 according to the embodiment.

FIG. 5 is a table of exemplary data managed by the management unit 12 of the server 10 according to the embodiment.

FIG. 6 is a table of exemplary data managed by the management unit 12 of the server 10 according to the embodiment.

FIG. 7 is a table of exemplary data managed by the management unit 12 of the server 10 according to the embodiment.

FIG. 8 is a flowchart of an exemplary operation of the server 10 according to the embodiment.

### DESCRIPTION OF EMBODIMENTS

Preferred embodiments of the present invention will be described in detail below with the accompanying drawings. Note that, in the following drawings, the same or similar parts are denoted with the same or similar reference signs. It should be noted that the drawings are schematic and, for example, the ratio between each dimension is different from the real. Therefore, for example, specific dimensions should be understood in consideration of the following descriptions. In addition, in some cases, parts are different in the dimensional relationship or ratio between drawings. In the present specification and the drawings, constituents substantially identical in function or configuration are denoted with the same reference signs and thus duplicate descriptions thereof will be omitted. In addition, any constituents not directly related to the present invention are not illustrated.

### First Embodiment

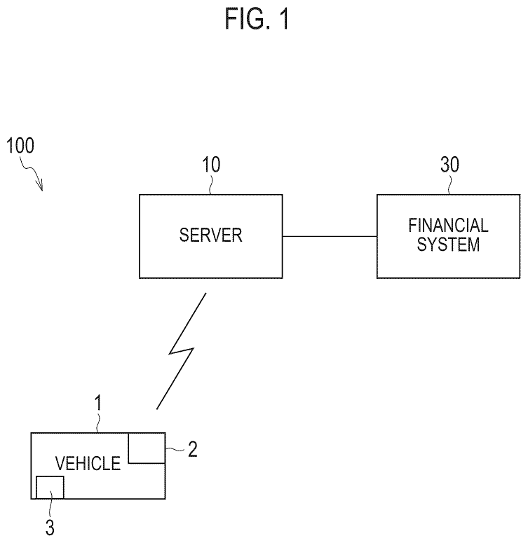

A service providing system 100 according to a first embodiment of the present invention will be described below with reference to FIGS. 1 to 8.

FIG. 1 illustrates an exemplary entire configuration of the service providing system 100 according to the present embodiment. As illustrated in FIG. 1, the service providing system 100 according to the present embodiment includes an onboard device 2 and a communication module 3 mounted on a vehicle 1, a server 10, and a financial system 20.

The service providing system 100 according to the present embodiment is capable of providing a service enabling, after execution of a credit or loan contract (namely, in the period of repayment), a modification in the terms of repayment to the borrowing of the user (namely, the driver) (hereinafter, referred to as the present service).

Note that a financial institution determines, at the time of execution of a credit or loan contract, the terms of repayment (e.g., the period of repayment and interest rate), based on credit information on the user, but makes no modification in the terms of repayment in the period of repayment. The reason is that the financial institution has difficulty acquiring, in the period of repayment, the credit information on the user.

In contrast to this, the service providing system 100 according to the present embodiment has such a configuration as described later or regards the performance of the user as the credit information on the user, enabling a modification in the terms of repayment to the user in the period of repayment.

The user corresponds to a user registered in the service providing system 100 such that the user is allowed to use the service described above.

The onboard device 2 according to the present embodiment corresponds to an electronic device installed in the vehicle 1 and has a communication function for communication, for example, with the server 10 through a radio network.

For example, a single onboard device 2 is installed per single vehicle 1. The installation place of the onboard device 2 to the vehicle 1 may be any place of the vehicle 1, provided that the onboard device 2 can control the vehicle 1.

The vehicle 1 may be a vehicle having an internal combustion engine or may be any type of vehicle, such as an electric vehicle (EV), a hybrid electric vehicle (HEV), a plug-in hybrid vehicle (PHV), or a fuel cell vehicle (FCV). Furthermore, the vehicle 1 may be any vehicle having wheels and thus may be, but is not particularly limited to, for example, a two-wheeled vehicle, a three-wheeled vehicle, or a six-wheeled vehicle, instead of an ordinary four-wheeled vehicle.

In a case where the onboard device 2 can be retrofitted, the onboard device 2 can be disposed at a place at which installation can be easily carried out, such as inside an instrument panel. From the viewpoint of theft prevention, the onboard device 2 can be disposed at a place from which the onboard device 2 is not easily detached, such as at the lower portion of an engine compartment. Furthermore, the onboard device 2 can be built in in advance in manufacturing the vehicle 1. The onboard device 2 may be fixed to the external portion of the vehicle 1, for example, through a two-sided adhesive tape.

The onboard device 2 is capable of collecting vehicular information on the vehicle 1 in which the onboard device 2 is installed. The vehicular information is information regarding the vehicle 1 and includes location information on the vehicle 1 and operating information on the vehicle 1. The operating information on the vehicle 1 included in the vehicular information includes, for example, information on power input of an external battery, IGN input information from a travel-state identifying line (ACC line or IG line), information on an external relay the controls the state of activation of the vehicle 1, speed information on the vehicle 1, tachometer information, tachograph information, door-lock information, immobilizer information, engine-start-button information, information on the quantity of depression of an accelerator pedal (including, for example, information on the degree of opening of a throttle valve. The same applies hereinafter), and various types of information enabling grasping of the operating situation of the vehicle 1.

The location information included in the vehicular information includes, for example, information acquired from a global positioning system (GPS).

The onboard device 2 may be capable of transmitting the collected vehicular information to the server 10 through the radio network and receiving a control signal from the server 10 through the radio network. The onboard device 2 is capable of controlling the vehicle, based on the control signal. For example, the onboard device 2 has a control function to perform activation control of the engine based on the control signal.

For example, the onboard device 2 may transmit, in real time or periodically, the operating information and location information on the vehicle 1 described above or may transmit, in a case where a change in the operating information and location information on the vehicle 1 described above fulfills a prescribed condition, the operating information and location information on the vehicle 1 described above.

In the present embodiment, the communication module 3 may have the entirety or part of the function of the onboard device 2 described above. For example, the communication module 3 corresponds to an electronic control device called an engine control unit (ECU) or an engine control module (ECM).

The onboard device 2 or the communication module 3 may collect, from a GPS or the like mounted on the vehicle 1, the location information on the vehicle described above through a wired or wireless in-vehicle network. Note that, needless to say, the GPS or the like may be part of the onboard device 2.

The onboard device 2 or the communication module 3 may collect, from various types of sensors or on-board diagnostics (OBD) mounted on the vehicle 1, the operating information on the vehicle 1 described above through the wired or wireless in-vehicle network. Note that the OBD may be mounted inside the communication module 3.

As such an in-vehicle network, used may be a network compliant with a standard, such as controller area network (CAN), local interconnect network (LIN), FlexRay, CAN FD, or 100 Base-T1.

The financial system 30 corresponds to a system managed by a financial institution and includes a server that manages credit information on the user of the vehicle 1 (driver of the vehicle 1).

As such a financial institution, applicable may be any entity capable of lending money to the user (e.g., any entity capable of legally lending money to the user). That is, examples of the financial institution include not only a bank, a credit sales company, a credit card company, and a consumer finance company but also a payment application program provider and a collective investment scheme. Examples of the money include cryptocurrency and realizable points (e.g., mileage and payment application program points).

The credit information corresponds to information regarding a credit or loan contract or a credit or loan application, namely, personal information regarding a registered objective deal fact. In a case where the financial institution described above is a payment application program provider, the credit information may include information regarding a payment application program contract or a payment application program application.

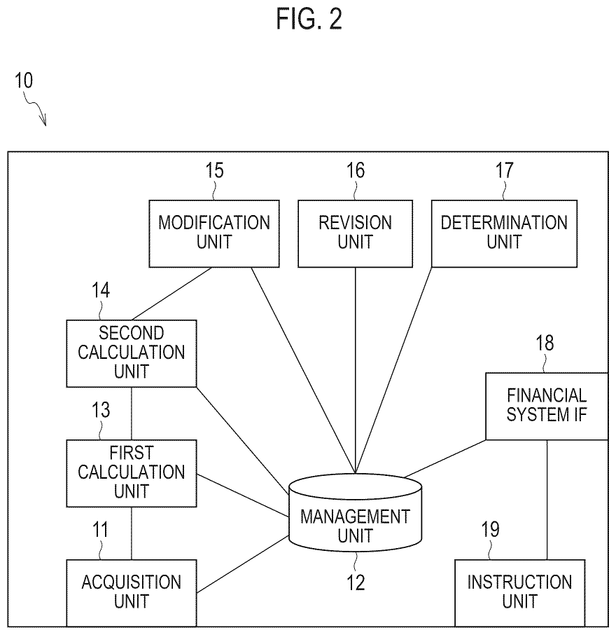

As illustrated in FIG. 2, the server 10 includes an acquisition unit 11, a management unit 12, a first calculation unit 13, a second calculation unit 14, a modification unit 15, a revision unit 16, a determination unit 17, a financial system IF 18, and an instruction unit 19.

The acquisition unit 11 acquires, from the onboard device 2 or the communication module 3 mounted on the vehicle 1 of the user, the operating information and location information on the vehicle 1 described above.

The management unit 12 manages various types of data necessary for achievement of a function as a server.

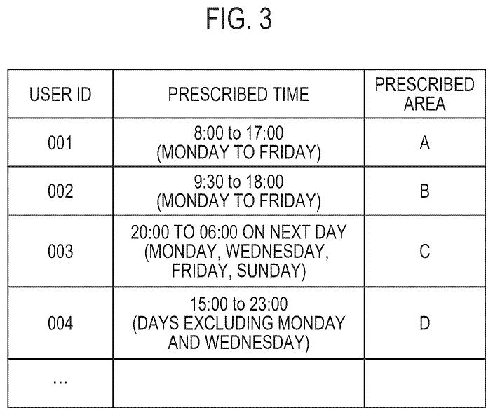

As illustrated in FIG. 3, the management unit 12 manages, as one of the various types of data, “user ID”, “prescribed time”, and “prescribed area” in association, as illustrated in FIG. 3.

The “user ID” corresponds to information for identifying each user. The “prescribed time” corresponds to information indicating the time during which each user works. The “prescribed area” corresponds to information indicating the area in which each user works. For example, the “prescribed time” may be referred to as “on-duty time” or “working time”. For example, the “prescribed area” may be referred to as “on-duty area” or “assigned area”.

The management unit 12 may manage the prescribed time and prescribed area described above, for example, based on the terms of contract executed for each user to start to use the present service.

The first calculation unit 13 calculates, based on the operating information and location information on the vehicle 1 acquired by the acquisition unit 11, an integrated value described below. The integrated value corresponds to an integrated value of the time of working of the user in the prescribed area within the prescribed time.

For example, the first calculation unit 13 may calculate, based on the location information on the vehicle 1 described above, the time during which the vehicle 1 of the user is located in the prescribed area within the prescribed time.

The first calculation unit 13 may calculate, for example, based on the IGN input information, the speed information, the tachometer information, or the tachograph information in the operating information on the vehicle 1 described above, the time of travelling of the vehicle 1 of the user within the prescribed time.

The “time of travelling of the vehicle 1” indicates the time during which the power of the vehicle 1 (e.g., the engine) is in operation (active). For example, the “time of travelling of the vehicle 1” includes the time during which the vehicle 1 remains stopped temporarily at a traffic light, a railroad crossing, or a pedestrian crossing.

Then, the first calculation unit 13 may regard an integrated value of the time of travelling of the vehicle 1 of the user in the prescribed area within the prescribed time as the integrated value of the time of working of the user in the prescribed area within the prescribed time.

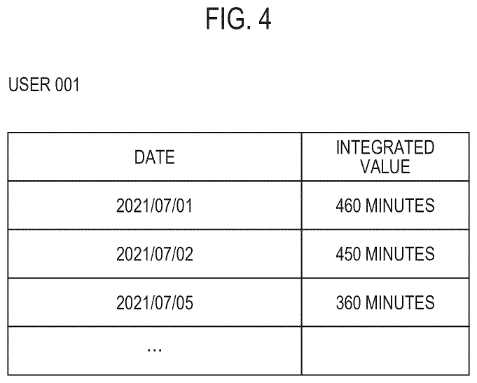

As illustrated in FIG. 4, the management unit 12 may manage, as one of the various types of data, the integrated value described above per user. For example, as illustrated in FIG. 4, the management unit 12 may manage the integrated value per day for each user. The management unit 12 may manage only the integrated value for the days on which each user works.

Note that the first calculation unit 13 may be capable of modifying, in accordance with the following cases (A) to (E), the method for calculating the integrated value described above, and may calculate the integrated value described above, based on the drive action of the user of the vehicle 1.

### (A) Case of Owner-Driver Taxi

In a case where the vehicle 1 described above is an owner-driver taxi, for example, the acquisition unit 11 may acquire, as the operating information on the vehicle 1 described above, information indicating four types of states: “vacant”, “occupied”, “out of service”, and “booked”. The information indicating the states may be information from a taximeter or information generated by another factor.

The “out of service” indicates the state of allowing no passenger to get in, such as the state of returning to the garage after work or the state of resting. The “booked” indicates the state of going to pick up the passenger having made a booking. The “vacant” indicates the state of finding any passenger. The “occupied” indicates the state of keeping a passenger in.

For example, the first calculation unit 13 may regard, as the integrated value described above, an integrated value of the time of the states of “occupied”, “vacant”, and “booked” of the vehicle 1 of the user in the prescribed area within the prescribed time.

### (B) Case of Transit Truck

In a case where the vehicle 1 described above is a transit truck, for example, the acquisition unit 11 may acquire, as the operating information on the vehicle 1 described above, information indicating three types of states: “in transit”, “in loading”, and “out of service”.

The “out of service” indicates the state of allowing no passenger to get in, such as the state of returning to the garage after work or the state of resting. The “in transit” indicates the state of going to a place for loading or the state of travelling with loads. The “in loading” indicates the state of loading.

For example, the first calculation unit 13 may regard, as the integrated value described above, an integrated value of the time of the states of “in transit” and “in loading” of the vehicle 1 of the user in the prescribed area within the prescribed time.

### (C) Case of Construction Machinery

In a case where the vehicle 1 described above is construction machinery, such as a power shovel or a crane vehicle, for example, the acquisition unit 11 may acquire, as the operating information on the vehicle 1 described above, information indicating whether or not prescribed working is being carried out.

For example, the first calculation unit 13 may regard, as the integrated value described above, an integrated value of the time of prescribed working of the vehicle 1 of the user in the prescribed area within the prescribed time.

### (D) Case of Vehicle for Use in Commuting

In a case where the vehicle 1 described above is a vehicle for use in commuting, for example, the first calculation unit 13 may regard, as the integrated value described above, the time of travelling on a prescribed route (e.g., the route from the parking space of the user's house to the parking space of the user's workspace) based on the operating information and location information on the vehicle 1 described above.

The first calculation unit 13 may add, to the integrated value described above, the time of parking at a prescribed place (e.g., the parking space of the user's workspace).

### (E) Case of Commercial Vehicle

In a case where the vehicle 1 described above is a commercial vehicle, for example, the first calculation unit 13 may regard, as the integrated value described above, the time of travelling on a prescribed route (e.g., a commercial route on the day) based on the operating information and location information on the vehicle 1 described above.

The second calculation unit 14 calculates a score for the user, based on the integrated value calculated by the first calculation unit 13.

For example, the second calculation unit 14 may substitute the integrated value into a prescribed computational expression to calculate the score.

For example, in accordance with the type of business of the user, the type of the vehicle 1, or the pattern of usage of the vehicle 1 (namely, each case described above), the second calculation unit 14 may use a different computational expression.

Alternatively, the second calculation unit 14 may rank the integrated value described above with a plurality of ranks in descending order of level and use a different computation expression per rank.

Alternatively, the second calculation unit 14 may rank the value resulting from division of the integrated value described above by the prescribed time (rate of operation) with a plurality of ranks in descending order of level and use a different computational expression per rank.

Alternatively, with each rank in association with a score, the second calculation unit 14 may allocate, to the user belonging to a rank in the ranks, the score associated with the rank.

Note that the second calculation unit 14 may use, as the score, the integrated value calculated by the first calculation unit 13.

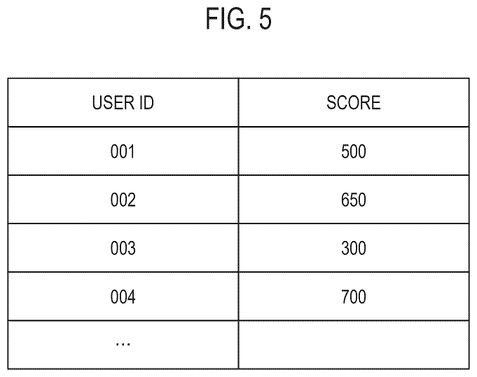

As illustrated in FIG. 5, the management unit 12 may manage, as one of the various types of data, the score described above per user.

The modification unit 15 may modify the terms of repayment, based on the score for the user calculated by the second calculation unit 14. For example, the terms of repayment include the period of repayment, the amount of repayment, and interest rate.

That is, the modification unit 15 modifies, based on the score for the user calculated by the second calculation unit 14, the terms of repayment, namely, at least one of the period of repayment, the amount of repayment, or the interest rate (rate of interest).

The “period of repayment” is information indicating the period of repayment of the amount of money that the user has borrowed. The “amount of repayment” is information indicating the amount of repayment of the amount of money that the user has borrowed. Note that the amount of repayment includes the principal and an interest amount. For example, the “amount of repayment” may be information indicating the balance of the amount of repayment or may be information indicating the amount of monthly repayment. The “interest” is information indicating the interest rate (rate of interest) on the amount of money that the user has borrowed. For example, the “interest” includes information indicating a fixed interest rate or a variable interest rate. The “interest” may include information indicating an annual interest rate or may include information indicating the amount of interest rate to be repaid monthly.

Specifically, based on the score for the user, the modification unit 15 may modify at least one of the period of repayment, the amount of repayment, or the interest rate to the user who has satisfied a certain criterion. For example, the certain criterion includes a criterion indicating that the score is larger than a prescribed value. In accordance with the score for the user who has satisfied the certain criterion, the modification unit 15 can modify the terms of repayment, flexibly.

For example, in accordance with the score for the user, the modification unit 15 may exempt a part of debit (e.g., part of the interest amount) and shorten the period of repayment without an increase in the amount of monthly repayment. In the case, the conversion unit 15 may manage, per score, information on an exemptable debit.

In accordance with the score for the user, the modification unit 15 may reduce the amount of monthly repayment (interest amount) with the period of repayment kept fixed. In the case, the modification unit 15 may manage, per score, the amount of reducible repayment.

In accordance with the score for the user, the modification unit 15 may reduce the interest rate. In the case, the modification unit 15 may manage, per score, reducible interest rate.

The modification unit 15 may lengthen the period of repayment with a reduction in the amount of monthly repayment and a reduction in the burden according to monthly repayment.

According to the configuration, the terms of repayment can be modified (relieved) to the user determined as being hardworking because the integrated value described above is large, that is, the score is high. As a result, a contribution can be made to an enhancement in the user's will to work.

Note that, in a case where the user is determined as being non-hardworking, that is, in a case where the integrated value described above is small, that is, the score is low, in accordance with the score for the user, the modification unit 15 may tighten the terms of repayment, such as a rise in interest rate, a reduction in the period of repayment, or an increase in the amount of repayment (interest amount).

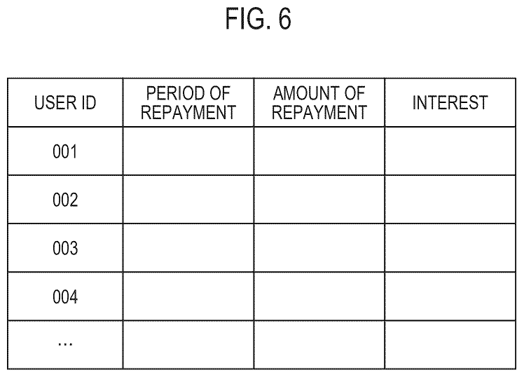

As illustrated in FIG. 6, the management unit 12 manages, as one of the various types of data, “user ID”, “period of repayment”, “amount of repayment”, and “interest” in association.

When the modification unit 15 modifies, based on the score for the user calculated by the second calculation unit 14, at least one of the period of repayment, the amount of repayment, or the interest rate, the management unit 12 modifies the “period of repayment”, “amount of repayment”, and “interest” illustrated in FIG. 6.

The second calculation unit 14 may calculate, further based on the credit information on the user, a score for the user.

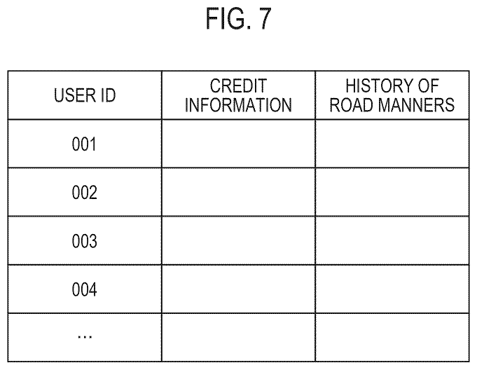

In the case, as illustrated in FIG. 7, the management unit 12 may manage, per user, the credit information on the user as one of the various types of data. The credit information on the user is credit information managed by the financial system 30 described above. The credit information on the user may include information acquirable when the user signs a credit or loan contract.

For example, in a case where the credit information on the user is higher than a prescribed criterion, the second calculation unit 14 may raise, by a previously determined point, the score for the user calculated based on the integrated value. In a case where the credit information on the user is lower than the prescribed criterion, the second calculation unit 14 may lower, by a previously determined point, the score for the user calculated based on the integrated value.

The second calculation unit 14 may modify, in accordance with the level of the credit information on the user with respect to the prescribed criterion, modify the level of the point for an increase or decrease.

According to the configuration, the terms of repayment can be modified to the user for which the integrated value described above is large and on which the credit information is high because of properly made repayments. As a result, a contribution can be made to not only a rise in the will to work described above but also an enhancement in the motivation for proper repayment.

The second calculation unit 14 may calculate, further based on the history of road manners of the user, a score for the user.

In the case, as illustrated in FIG. 7, the management unit 12 may manage, per user, the history of road manners of the user as one of the various types of data.

The history of road manners of the user is information including, for example, the history of driving over legally permitted speeds (e.g., the total number of times or the total time) and information indicating the total number of times of sudden acceleration, the total number of times of honking, the total number of times of sudden braking, the total number of times of drowsy driving, or the total number of times of drunk driving.

For example, the number of times of drowsy driving can be obtained based on images of the user's face captured by a camera with which the vehicle 1 is provided and can be obtained based on data of the concentration of alcohol in breath detected by a breath sensor with which the vehicle 1 is provided.

For example, in a case where the history of road manners of the user is higher than a prescribed criterion, the second calculation unit 14 may raise, by a previously determined point, the score for the user calculated based on the integrated value. In a case where the history of road manners of the user is lower than the prescribed criterion, the second calculation unit 14 may lower, by a previously determined point, the score for the user calculated based on the integrated value.

For example, the prescribed criterion may be set based on at least one of the total number of times of driving over legally permitted speeds, the total time of driving over legally permitted speeds, the total number of times of sudden acceleration, the total number of times of honking, the total number of times of sudden braking, the number of times of drowsy driving, or the number of times of drunk driving.

The second calculation unit 14 may modify, in accordance with the history of road manners of the user, the level of the point for an increase or decrease.

Note that the history of road manners may be transmitted as the operating information on the vehicle 1 from the onboard device 2 or may be generated by the second calculation unit 14 from the operating information on the vehicle 1.

According to the configuration, the terms of repayment can be relieved to any user who has good road manners. As a result, a contribution can be made to an improvement in the user's road manners.

Note that, in the present embodiment, the server 10 may include a single calculation unit functioning as the first calculation unit 13 and the second calculation unit 14, instead of including the first calculation unit 13 and the second calculation unit 14 separately.

The revision unit 16 revises, in response to fulfillment of a prescribed condition, at least either the integrated value or the score described above.

For example, the prescribed condition may include a condition that the user has notified the server 10 of an unavoidable reason, such as ceremonial occasion or member's illness in the family. Alternatively, the prescribed condition may include a condition that the server 10 has detected an occurrence, such as a disaster or an accident.

For example, in a case where the user has notified the server 10 of such an unavoidable reason as described above, the revision unit 16 may increase the integrated value for the user by a previously determined value or may raise the score for the user by a previously determined point.

According to the configuration, in a case where an unavoidable reason is notified, the integrated value or the score described above can be protected from deteriorating.

The determination unit 17 may determine, based on the score for the user, a service providable to the user.

For example, the determination unit 17 may determine that the execution of a new loan (e.g., an education loan) or a new lease can be provided to any user who has a score not less than a prescribed value.

The determination unit 17 may define, in advance, providable services corresponding to scores.

According to the configuration, a new service can be provided to any user who is hardworking. As a result, a contribution can be made to a further enhancement in the user's will to work.

The financial system IF 18 serves as an interface with the financial system 30.

For example, at a prescribed timing or in response to a request from the financial system 30, the financial system IF 18 transmits, to the financial system 30, the score for a user or the terms of repayment to the user managed by the management unit 12.

The financial system IF 18 acquires, from the financial system 30, the credit information on the user described above.

The instruction unit 19 grasps the situation of repayment regarding the borrowing of a user and transmits, in accordance with the situation of repayment, a control command for switching the vehicle 1 between the activation unallowable state and the activation allowable state to the onboard device 2.

For example, the instruction unit 19 may transmit, to the onboard device 2 mounted on the vehicle 1 of a user in arrears with the user's payments, a control command for controlling the vehicle 1 to switch to the activation unallowable state.

The instruction unit 19 may acquire the situation of repayment through the financial system IF.

Note that the data managed by the management unit 12 described above may be in such formats as illustrated in FIGS. 3 to 7 or in other formats.

For example, the first calculation unit 13, the second calculation unit 14, the modification unit 15, the revision unit 16, and the determination unit 17 may be each achieved with a processor, such as a CPU.

For example, the acquisition unit 11, the financial system IF, and the instruction unit 19 may be each achieved with a communication module.

Furthermore, the management unit 12 may be achieved with a storage medium, such as a hard disk or a memory, or may be achieved in cooperation with a storage medium on cloud computing.

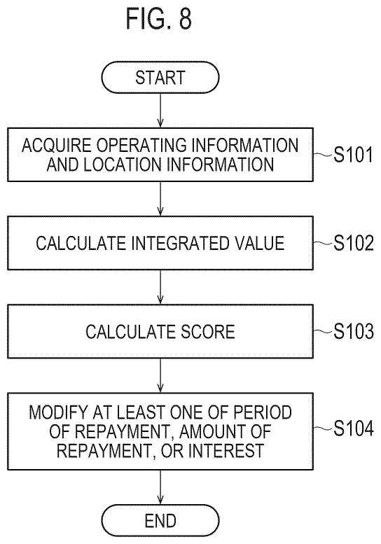

An exemplary operation of the server 10 according to the present embodiment will be described below with reference to FIG. 8.

As illustrated in FIG. 8, in step S101, the server 10 acquires, from the onboard device 2 mounted on the vehicle 1 of each user, the operating information and location information on the vehicle 1.

In step S102, the server 10 calculates an integrated value for each user, based on the operating information and location information on the vehicle 1.

In step S103, the server 10 calculates a score for each user, based on the integrated value for each user.

In step S104, the server 10 modifies, based on the score for each user, at least one of the period of repayment, the amount of repayment, or the interest rate to any user who has satisfied a certain criterion.

The server 10 according to the present embodiment enables achievement of further improvement of hardworking drivers' lives, leading to rises in the drivers' wills to work.

### Modification

Note that, in the embodiment described above, given has been a case where the service providing system 100 provides a service enabling, after the execution of a credit or loan contract (namely, in the period of repayment), a modification in the terms of repayment to the borrowing of the user (namely, the driver). In the present modification, the service providing system 100 provides a service enabling, after the execution of a lease contract (namely, in the period of contract), a modification in the terms of payment (lease payment).

In the present modification, the modification unit 15 modifies, based on the score described above, the terms of payment (contractual coverage).

Provided may be a program for causing a computer to perform each piece of processing that the server 10 performs. The program may be recorded in a computer-readable medium. Use of a computer-readable medium enables installation of the program on a computer. The computer-readable medium in which the program is recorded may be a non-transitory recording medium. Such a non-transitory recording medium may be, but is not particularly limited to, a recording medium such as a CD-ROM, a DVD-ROM, or a hard disk.

The present invention has been described in detail with the embodiment described above. However, it is obvious to those skilled in the art that the present invention is not limited to the embodiment in the present specification. The present invention can be carried out in aspects altered and modified without departing from the gist and scope of the present invention in the claims. Therefore, the present specification is intended for exemplificative description and thus does not have any limitative meanings to the present invention.

1. A server comprising:
an acquisition unit that acquires operating information and location information on a vehicle of a user;
a management unit that manages the user, a prescribed time, and a prescribed area in association;
a first calculation unit that calculates, based on the operating information and the location information on the vehicle, an integrated value of a time of working of the user in the prescribed area within the prescribed time;
a second calculation unit that calculates, based on the integrated value, a score for the user; and
a modification unit that modifies, based on the score, at least one of a period of repayment, an amount of repayment, or interest rate.

2. The server according to claim 1, wherein
the second calculation unit calculates the score for the user, further based on credit information on the user.

3. The server according to claim 1, wherein
the second calculation unit calculates the score for the user, further based on history of road manners of the user.

4. The server according to claim 1, further comprising a determination unit that determines, based on the score, a service providable to the user.

5. The server according to claim 1, further comprising a revision unit that revises, in response to fulfillment of a prescribed condition, at least either the integrated value or the score.

6. A program stored on a non-transitory computer-readable medium for causing a computer to function as a server,
the server comprising:
an acquisition unit that acquires operating information and location information on a vehicle of a user;
a management unit that manages the user, a prescribed time, and a prescribed area in association;
a first calculation unit that calculates, based on the operating information and the location information on the vehicle, an integrated value of a time of working of the user in the prescribed area within the prescribed time;
a second calculation unit that calculates, based on the integrated value, a score for the user; and
a modification unit that modifies, based on the score, at least one of a period of repayment, an amount of repayment, or interest rate.
